(19) United States
(12) Patent Application Publication
(10) Pub. No.: US 2016/0157966 A1
(43) Pub. Date: Jun. 9, 2016

(54) DEVICE FOR POSITIONALLY FIXING A MOULDING, AND SUITABLE METHOD THEREFOR

(71) Applicant: Merz Dental GmbH, LütJenburg (DE)

(72) Inventors: Christian BOROWSKI, Kiel (DE); Jody Paul Spalt, Lütjenburg (DE)

(73) Assignee: Merz Dental GmbH, Lütjenburg (DE)

(21) Appl. No.: 14/442,687

(22) PCT Filed: Nov. 15, 2013
(86) PCT No.: PCT/EP2013/003457

§ 371 Date: Feb. 18, 2016

(30) Foreign Application Priority Data
Nov. 15, 2012 (DE) 10 2012 111 024.7

(51) Int. Cl. A61C 11/08; A61C 13/34

(52) U.S. Cl. CPC A61C 11/08; A61C 13/34

(57) ABSTRACT

The invention describes a device for positionally fixing a moulding comprising a base surface having at least one fixing element for the moulding, characterized in that at least one positioning means is provided which interacts with the fixing element, and the moulding has at least one position marking which interacts with the positioning means.

The present invention relates to a device for positionally fixing a moulding consisting of a base surface with at least one fixing element for the moulding according to the preamble to claim 1, and to a corresponding method for positionally fixing a moulding, in particular using the device.

In the field of dental technology, for the moulding of a jaw arrangement a dental impression tray, which is preferably shaped like a spoon, is generally used with which a plastic mould is respectively made for the upper jaw and the lower jaw. After the mould has been made with the aid of a so-called bite fork, the occlusal plane is determined with which, by means of a so-called articulator, the respective jaw moulds are pre-set and adapted to the correct position. Moulds of jaws and teeth thus constitute the basis for the work of dental technicians. With the aid of these moulds models are then produced, e.g. from dental stone, so that a situation is created which is also to be found in the patient's mouth. In addition, the relative position of the jaws in relation to one another is determined in an articulator by means of bite registration. The models are prepared differently for the following measures. With an individual impression tray, a bite template or a prosthesis one works directly on the model. In order to produce stainless steel structures, a model is produced with which the individual teeth are worked on separately, but can clearly be placed back on the model base. With this mould the dental technician produces the working model. Next comes the production of bite templates with the aid of which the dentist sets up the relationship between the jaws and establishes the occlusal plane. After deflasking, the prosthesis is placed back in the articulator so as to correct the occlusion, if so required, and it is finally elaborated and polished.

Articulators are devices that simulate the movement of the jaw joint. For this purpose plaster models, for example, of the dental arches of the upper and the lower jaw in occlusion are fitted in the articulator. Next the movement of the jaws in relation to one another can be simulated, and this is indispensible for the production of artificial dentition, partial and total prostheses or splints. The displacement of the rows of teeth in relation to one another when teeth come into contact due to the sliding movements of the lower jaw can thus be recorded. The form of the sliding movements depends, among other things, upon the position of the teeth, the cusp shape and the joint pathway in the jaw joint.

Instead of the known plastic moulding, over the last few years digital moulding has been becoming more and more established in the dental technology market. In this connection mechanical moulding with the aid of a spoon impression can be dispensed with and the patient's oral cavity is only recorded digitally. The advantage of this digital moulding is that the dentist is given the possibility of recognising almost in real time whether the data obtained for a digital dental impression are sufficient. However, the digital quality of the dental impression depends on the computer programme used and the associated technical equipment, and also on other expensive applications.

Once the digital mould, i.e. the digitally recorded oral cavity of the patient, is available, by means of the latter the features of the respective upper and lower jaw are reproduced in the conventional manner and the occlusal position is prepared in the articulator with the aid of the bite fork which is also used. Nevertheless, the dentist then has to adapt the prosthesis parts or also the total prosthesis to the upper and/or the lower jaw in situ, once again depending on the accuracy and the error-free work of the dental technical, possibly in a number of processes, it being necessary in part to return the prosthesis to the dental technical depending on error frequency and inaccuracy with problematic occlusal positions.

In all well-established methods, be it analogue/mechanical or digital moulding, the respective optimal alignment and positioning of the upper jaw dental prosthesis in relation to the lower jaw dental prosthesis is a problematic step. The respective procedural steps of both the dental technician and the dentist can be influenced depending on the accuracy of the alignment between the upper jaw and the lower jaw dental prosthesis. Therefore, the mould, i.e. the dental impression, constitutes the most important link between the treatment on the patient performed by the dentist and the work of the dental technician in the laboratory. The stability and the fixing of the moulding to be worked on in the articulator plays an essential role here.

A distinction is made between average value articulators, partly-adjustable articulators and full value articulators, the different models differing as regards the setting possibilities relating to the individual adjustment of the Bennett angle, joint pathway inclination, terminal hinge axis, anterior tooth guidance etc. However, most average value articulators do not offer individual settings, in comparison to this all of the values to be determined being freely adjustable in full value articulators. When placing the model in the articulator, it is generally only aligned so that it rests against a reference mandrel with the incisal point and the occlusal plane is aligned parallel to the plane of the table and the median plane of the model is aligned at right angles to the condyle connecting line. Therefore, a co-ordinate origin in relation to the overall model and individual tooth positions is disadvantageously not given.

Therefore, the object underlying the present invention is to guarantee a high degree of accuracy with regard to the respective position of the upper jaw dental prosthesis in relation to the lower jaw dental prosthesis during the moulding process or in the preparation of a dental model and to provide an appropriate device and a corresponding method. Another object is to obtain optimal knowledge of the upper or lower jaw to be moulded and of the corresponding positioning of the moulded upper and lower jaw and optimal digitalisation.

These objects are achieved by the device by means of the features according to claim 1 and by the method by means of the features according to claim 12.

One essential aspect of the present invention is that there is provided on the positional fixing device for the moulding at least one positioning means that co-operates with a fixing element, and the moulding has at least one position marking that co-operates with the positioning means.

In the handling of articulators or scanning devices it as desirable, as mentioned above, to be able to fix the upper and the lower part at the zero point of the occlusion. As a solution, according to one design of the device according to the invention a positioning means is proposed in conjunction with a position marking which is disposed on the upper and/or the lower part and which can be engaged detachably with one another. Thus, lateral movement components of the upper and the lower part in relation to one another and in relation to the overall device are ruled out. The central/static position of the occlusion, i.e. the zero point of the occlusion, is thus fixed in relation to the upper and the lower part in the co-ordinate origin of the device.

An elastomer impression or a dental model is used as the moulding which has at least one position marking, for example one or more groove-like recesses arranged on the lower side or the upper side. By means of the additional positioning means as a component of the positional fixing device which are connected, at least with form-locking, to the base surface by the fixing means, it is possible to determine the respective dental impression and/or the model according to the positioning in the device almost exactly to a co-ordinate zero point so that the adaptation work of the dental technician is reduced to a minimum. With this positioning means it is also possible in co-operation, i.e. engagement, with the position marking, for the upper jaw mould and the lower jaw mould or the corresponding dental model to be able to be aligned and encoded both horizontally and vertically with high precision and stability to the zero point. This moulded part zero point is the co-ordinate origin of the moulded part to be worked on a machine tool, for example a mould machining device or a digital scanning device. It is recorded and defined, for example, by a corresponding NC programme. All of the path information that is programmed into the NC programme relates to this point here. Generally, the position co-ordinates only relate to individual teeth with reference to the adjacent tooth. In order to set individual patient values on the articulator, these are measured laboriously on the patient as an individual registration.

Additional advantageous configurations are the subject matter of the sub-claims.

In addition to the positioning means, the positional fixing device contains at least one fixing element and a base surface. Here the fixing element is preferably a recess, for example a groove within the base surface. The fixing element and the base surface therefore provide a fixed point on the tool side which, by means of the positioning means, is in a clear relative position with respect to the position markings of the moulded part.

It is also preferred if the base surface constitutes a round plane surface.

The at least one positioning means is preferably made in the shape of a bar.

Furthermore, the positioning means are preferably made to be round.

The surfaces of the positioning means are preferably made with form-locking to the fixing elements and the position markings. If, for example, the position marking is provided as a notch or recess in the bottom region of the respective dental moulds, i.e. on the upper or the lower side, by means of the simple technical implementation an additional positioning means is thus provided which enables a stable positionable allocation of the upper jaw to the lower jaw. For example, the positioning bars engage with form-locking in the fixing grooves.

Preferably, at least 3 positioning means are arranged here, in particular in the circumferential direction of the base surface. It has proven to be particularly advantageous if at least three position markings, and so 3 positioning means, are provided in an additionally centrosymmetrical arrangement because in this way, the respective upper and lower jaws can be configured optimally. Depending on the size of the mould to be worked, it is advantageous, for example, to provide five position markings and so five positioning means. In particular, an odd number of position markings are formed so that a symmetrical arrangement in relation to the centrally arranged fixing is respectively possible.

Preferably, the positioning means are connected in a force-locking and anti-slip manner to the base element.

The fixing elements are preferably arranged rotationally symmetrically. It is also advantageous, for example, if the position markings and the positioning means are arranged rotationally symmetrically because the allocation and positioning of the upper and the lower jaw can thus be undertaken more easily. An advantageous arrangement of the position markings in the labial region enables in particular simple placing on the articulator for the dental technician.

It is also preferred if a scanning device is provided with which the moulding is scanned digitally, for example an optoelectronic scanner.

The moulding is preferably a moulded body, preferably a moulded body for the dental prosthesis or for a partial or total prosthesis. Alternatively, the moulding is a positive dental model.

The method according to the invention for positionally fixing a moulding, in particular using the previously described device, has the following steps:

a) providing a base surface with at least one fixing element,

b) providing a moulding with position markings, and

c) providing positioning means so that the positioning means co-operate with form-locking with the fixing element and the position markings for the positional fixing of the moulding.

The moulding is preferably digitalised here by the positional fixing, and is preferably digitalised in a reproducible manner.

Preferably, the moulding is positionally fixed onto the positioning means such that it can be removed.

Due to the provision of the base surface, the fixing elements and the positioning means, an adaptation is made during the digitalisation process in co-operation with the position markings of the moulding by means of which the position of the jaws in relation to one another, the position of the teeth in relation to one another and also the horizontal occlusal position are determined and established or clearly fixed. With this measure it is achieved that the error sources, which may occur for example with separate moulding of an upper jaw and a lower jaw, which then require complex preparation by the dental technician once again in the articulator, are no longer present. Due to the presence of the position markings and the positioning means one can in this regard dispense with a technically more complex digital overall mould in the oral cavity.

If, moreover, the position marking is in the form of a so-called surface pairing, the possibility is thus provided of the surface pairing also being reproduced in the articulator and so there being almost one hundred percent positioning of the jaw position of the upper and the lower jaw. The surface pairing of the position marking in co-operation with a bite registration element also increases the positional fixing so that after production of the dental impression the dental technician does not have to make a complex correction in the articulator.

Moreover, if a bite fork is additionally used to determine the occlusal plane, almost all possible parameters for producing a dental impression and so for producing the synthetic dental prosthesis are provided, the moulding of the respective upper and lower jaw contour required for this being able to take place in one procedural step.

Additional advantages, features and possible applications of the present invention emerge from the following description of preferred exemplary embodiments in association with the drawings. These show as follows:

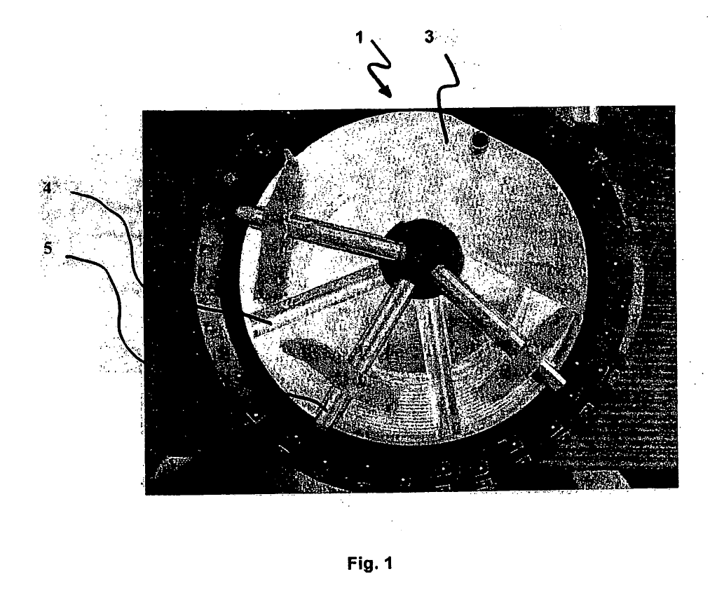

FIG. 1 the positional fixing device according to the invention in a top view; and

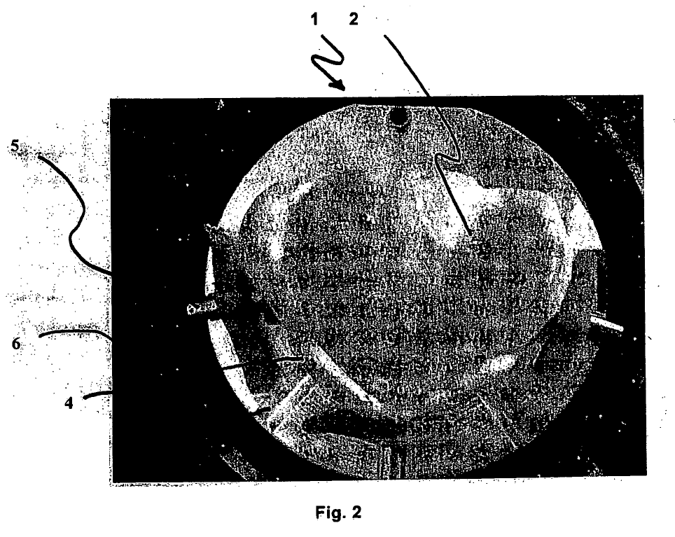

FIG. 2 an illustration of the arrangement of a dental mould as a moulding on a positional fixing device according to the invention in a top view.

In FIG. 1 the positional fixing 1 device according to the invention is shown which, in this case, does not yet have a moulding 2 for the jaw. In addition to the positioning means 5, which is a round metal bar here, the positional fixing device 1 has at least one fixing element 4 and a base surface 3. Here the fixing element 4 is preferably a recess, made here as a groove within the base surface 3. Furthermore, the base surface 3 constitutes a round plane surface.

The positioning means 5 co-operate in a form-locking manner with the fixing element 4 and the position markings 6 disposed on the lower side of a moulding 2 in order to positionally fix a moulding. For example, the 3, 5 or 7 positioning bars engage with form-locking in the 3, 5 or 7 fixing grooves of the base surface 3 and the lower-side position markings 6 of the moulding 2 and so fix its position.

The positioning means 5 thus provides the dental technician with a simple instrument for directly copying the respective bite situation and for fixing it accordingly. With the positional fixing device 1 in association with the dental mould 2 with at least one position marking 6 and the positioning means 5, a bi-functional mould machining device is thus provided which, in addition to the well-established function, i.e. the moulding of the respective jaw function, additionally adopts the function of the mechanical and/or digital positional fixing of the dental impression as such. According to the invention, the basic concept of the positional fixing device 1 with the dental mould and the dental model as a moulding 2 in the latter, is that the moulding and the stabilised and positionally correct digital registration of the jaws are provided in a single process. In addition to the moulding of the two jaws, mechanical and/or digital bite registration is therefore also possible in a single step.

The moulding zero point is the co-ordinate origin here of the part to be worked on the device, for example a scanner or an articulator.

FIG. 2 shows the configuration of a positional fixing device 1 on which a moulding 2 or the dental model is positioned, the dental impression having three position markings 6 on the lower side here. In this form, the position markings 6 are provided as recesses or grooves which extend from palatinal to labial and the vestibularly located recess preferably being positioned centrally or rotationally symmetrically.

First of all, the upper jaw, for example, can additionally be positioned correctly by means of a bite fork and by using references relating to the scull. A moulding compound is used here as a key which is provided as the carrier of specific situation data which can be generated by the position markings 6 and so contains information with regard to the occlusal plane. After the pre-positioning with all of the important reference points the functional mould is made, i.e. after inserting the dental impression device both for the upper and for the lower jaw which has the corresponding position markings 6, a bite registration element is positioned between the upper jaw dental impression tray and the lower jaw dental impression tray, by means of which the reference of both dental impression trays is produced, and so is provided by means of the bite registration element. With the aid of a hard silicon the lower jaw is thus aligned and encoded horizontally and vertically to the upper jaw. In this connection the position markings 6 and the positioning bars 5 in particular play a particular encoding role because by means of the position markings 6 and the positioning bars 5 the positional fixing of the upper and lower jaw enable optimal spatial fixing by means of which all necessary reference points are provided in a moulding process which reduce the after-treatment carried out by the dental technician and the dentist to a minimum. The downstream scanning process for producing a digital impression therefore takes place with accurate recording of the positionally fixed coordinate origin of the moulding 2 in the device 1.

All of the technical features disclosed in the present documents are claimed as essential to the invention.

1. A system for positionally fixing a moulding, comprising:
a positional fixing device with a base surface with at least one fixing element for the moulding and the moulding being disposed on the positional fixing device; at least one positioning means that co-operates with the fixing element,
wherein the moulding has at least one position marking that co-operates with the positioning means, the surface of the positioning means being made with form-locking to the fixing elements and the position markings.

2. The system of claim 1, wherein the fixing element is a recess.

3. The system of claim 1, wherein the base surface is a round plane surface.

4. The system of claim 1, wherein the positioning means is/are in the shape of a bar.

5. The system of claim 4, wherein the positioning means are round.

6. The system of claim 1, wherein at least three positioning means are arranged in a circumferential direction.

7. The system of claim 1, wherein the positioning means is/are connected in a force-locking or anti-slip manner to the base surface.

8. The system of claim 1, wherein the fixing elements are arranged rotationally symmetrically.

9. The system of claim 1, wherein a scanning device is provided with which the moulding is scanned digitally.

10. The system of claim 1, wherein the moulding is a moulded body.

11. A method for positionally fixing a moulding, comprising:
a) providing a base surface with at least one fixing element;
b) providing a moulding with position markings;
c) providing positioning means so that the positioning means co-operate with form-locking with the fixing element and the position markings for the positional fixing of the moulding.

12. The method of claim 11, wherein the moulding is digitalised by the positional fixing.

13. The method of claim 11, wherein the moulding is positionally fixed onto the positioning means such that it can be removed.

14. The system of claim 10, wherein the moulding is a moulded body for the dental prosthesis or for a partial or total prosthesis.

15. The system of claim 12, wherein the moulding is digitalized in a reproducible manner.
